(19) United States
(12) Patent Application Publication
(10) Pub. No.: US 2006/0235807 A1
(43) Pub. Date: Oct. 19, 2006

(54) COMPETITIVE CIRCUIT PRICE MODEL AND METHOD

(75) Inventor: Joanne Ferris, Essex, VT (US)

Correspondence Address: DOWNS RACHLIN MARTIN PLLC, 199 MAIN ST, PO BO 190, BURLINGTON, VT, 05402-0190, US

(73) Assignee: INTERNATIONAL BUSINESS MACHINES CORPORATION, Armonk, NY (US)

(21) Appl. No.: 10/907,874

(22) Filed: Apr. 19, 2005

(51) Int. Cl. G06F 17/00

(52) U.S. Cl. 705/400

(57) ABSTRACT

A method of calculating a competitive base wafer cost for use in a model for calculating a packaged integrated circuit (IC) cost. The method includes determining a base wafer price for a first wafer technology at a desired time of analysis and applying a competitive wafer gross margin for the desired time of analysis to the base wafer price to determine the competitive base wafer cost.

### FIELD OF THE INVENTION

The present invention generally relates to the field of integrated circuit (IC) cost/price models. In particular, the present invention is directed to a model of calculating a competitive base wafer cost.

### BACKGROUND OF THE INVENTION

Professionals in the integrated circuit (IC) field have an ongoing interest in being able to predict and estimate competitive costs and prices for packaged semiconductor products. The ability to gauge competitive costs and prices can assist an IC professional in designing cost effective products, in negotiating during procurement, and in other aspects of IC design and manufacture.

Various prior cost tools that are available, tend to be cumbersome, and require inputs that are typically beyond an IC professional's knowledge and ability to ascertain. Most prior tools require inputs that are specific to a particular fabricator instead of generally applicable information that would be useful across a spectrum of fabricators. Previously available tools require a bottom's up cost analysis approach. Various prior cost tools calculate a cost of wafer production directly from the specific values of a particular fabricator and typically require inputs unavailable to most procurement and design professionals, such as the year the fabricator's facilities were built, the number of tools fully depreciated, fabricator utilization rates, labor rates, fabricator capacity, and yields. Typically, the interfaces of such tools are user-unfriendly and complex with numerous input fields. Another problem with prior tools is a lack of flexibility in being able to specify differing IC packaging specifications. Prior tools typically use a package with predefined specifications.

### SUMMARY OF THE INVENTION

In one aspect of the present invention, a method of calculating a competitive base wafer cost for use in a model of calculating a packaged integrated circuit (IC) cost for a first integrated circuit of a first IC technology is provided. The method includes providing a model of calculating a packaged IC cost; determining a base wafer price for a first wafer technology at a desired time of analysis; and applying in the model of calculating a packaged IC cost a competitive wafer gross margin for the desired time of analysis to the base wafer price to determine the competitive base wafer cost.

In another aspect of the present invention, a method of calculating a competitive base wafer cost for use in a model for calculating a packaged integrated circuit (IC) cost for a first integrated circuit of a first IC technology is provided. The method includes (a) determining a base wafer price for a first wafer technology at a desired time of analysis; and (b) applying a competitive wafer gross margin for the desired time of analysis to the base wafer price to determine the competitive base wafer cost. The competitive wafer gross margin is based on information obtained by: (i) determining a second wafer technology at the statistical mode of a wafer distribution for a first foundry for an available date; (ii) determining a first amount of time from an initial date of production of the second wafer technology to the available date; (iii) plotting a function using a first point at an initial time of a gross margin versus time plot, a second point at a terminal time of the gross margin versus time plot, and a third point at the first amount of time from the initial time of the gross margin versus time plot, the first point corresponding to an industry maximum attainable wafer gross margin, the second point corresponding to an industry minimum attainable wafer gross margin, the third point corresponding to an industry available gross margin for the first foundry for the available date; and (iv) assigning a value from the function as the competitive wafer gross margin.

In yet another aspect of the present invention, a computer readable medium containing computer executable instructions implementing a method of calculating a competitive base wafer cost for use in a model for calculating a packaged integrated circuit (IC) cost for a first integrated circuit of a first IC technology is provided. The instructions include a first set of instructions for providing a model of calculating a packaged IC cost; a second set of instructions for determining a base wafer price for a first wafer technology at a desired time of analysis; and a third set of instructions for applying in the model of calculating a packaged IC cost a competitive wafer gross margin for the desired time of analysis to the base wafer price to determine the competitive base wafer cost.

### BRIEF DESCRIPTION

For the purpose of illustrating the invention, the drawings show a form of the invention that is presently preferred. However, it should be understood that the present invention is not limited to the precise arrangements and instrumentalities shown in the drawings, wherein:

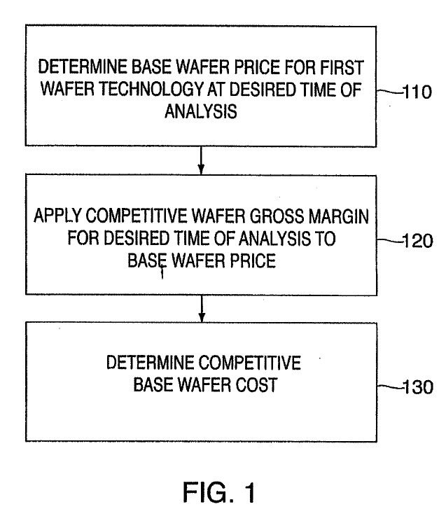

FIG. 1 shows a flow diagram of an example method according to the present invention.

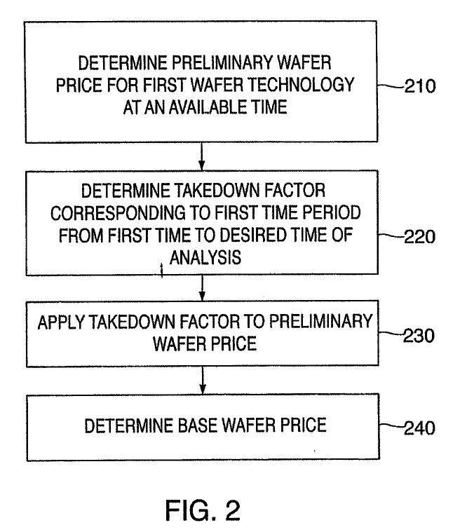

FIG. 2 shows a flow diagram of an example method according to the present invention.

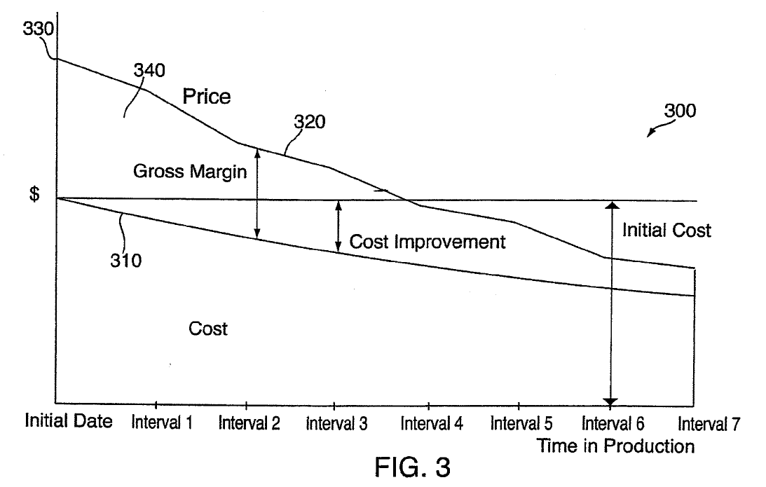

FIG. 3 shows an example diagram of cost versus price over time.

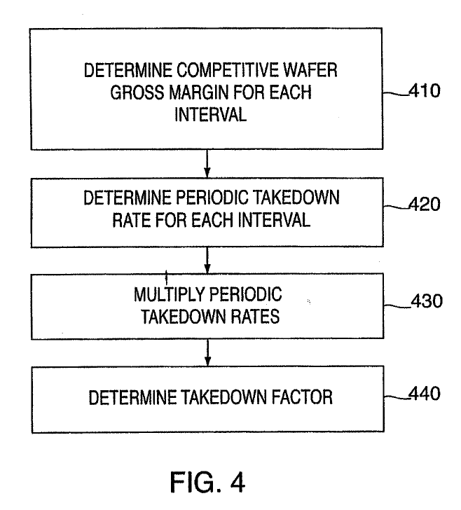

FIG. 4 shows a flow diagram of an example method according to the present invention.

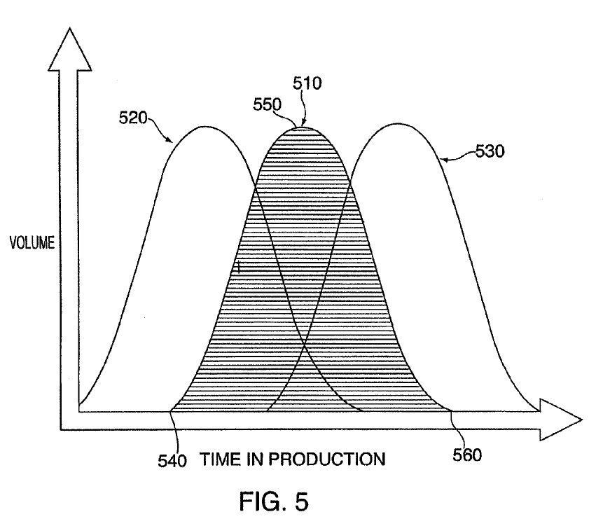

FIG. 5 shows an example wafer distribution of three wafer technologies over time.

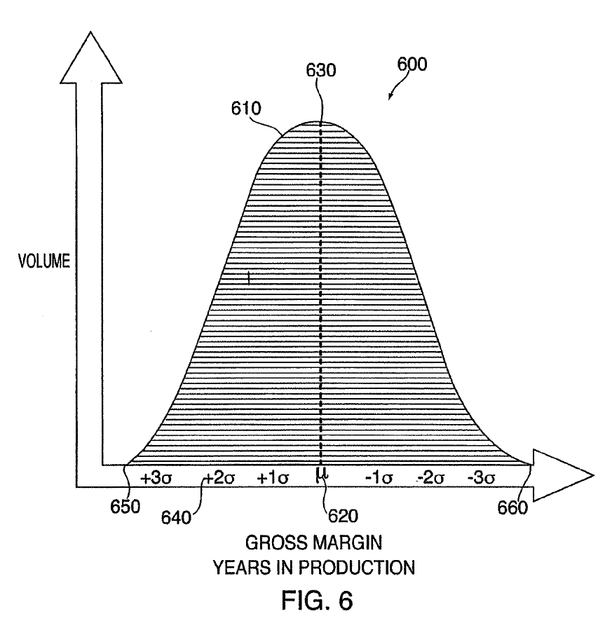

FIG. 6 shows an example plot of wafer gross margin and time versus wafer volume.

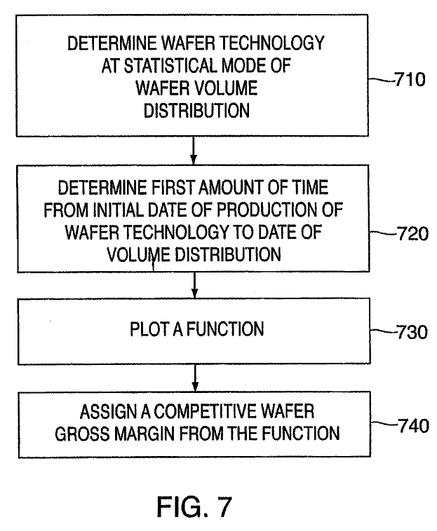

FIG. 7 shows a flow diagram of an example method according to the present invention.

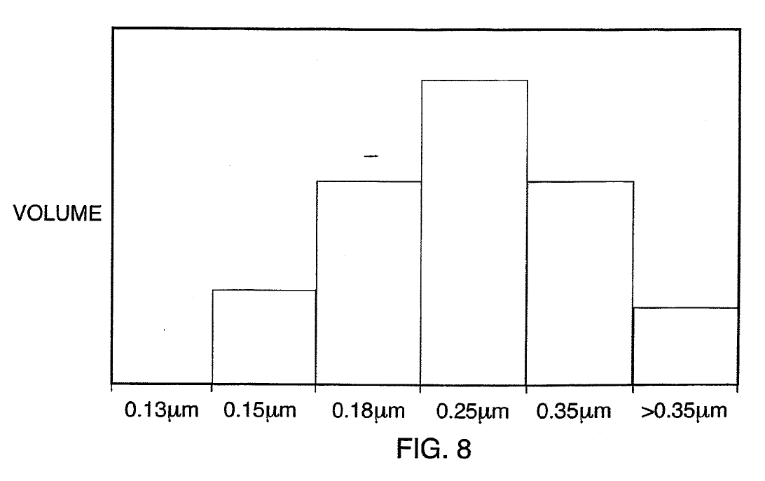

FIG. 8 shows a plot of an example wafer distribution.

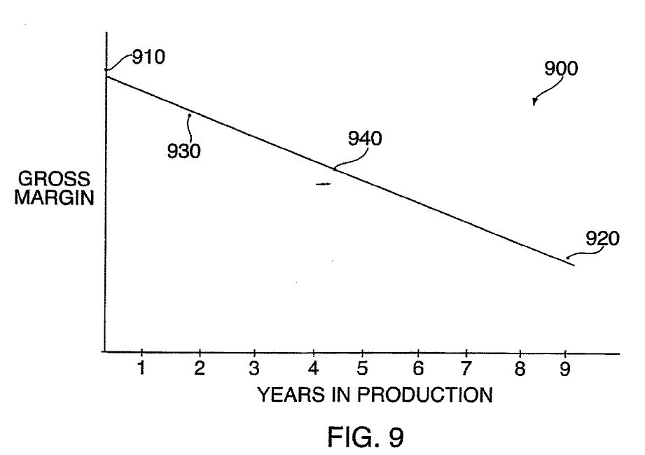

FIG. 9 shows an example plot of gross margin versus time in production.

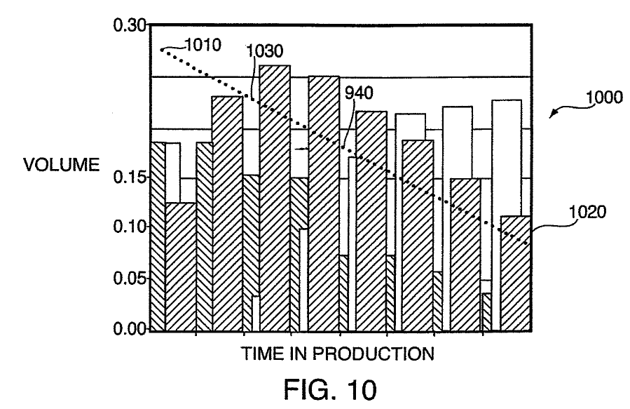

FIG. 10 shows an example plot of wafer volume versus time in production.

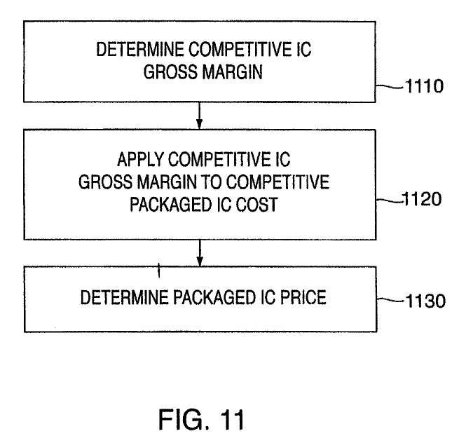

FIG. 11 shows a flow diagram of an example method according to the present invention.

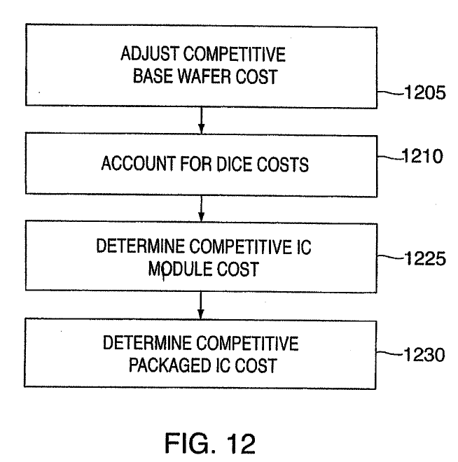

FIG. 12 shows a flow diagram of an example method according to the present invention.

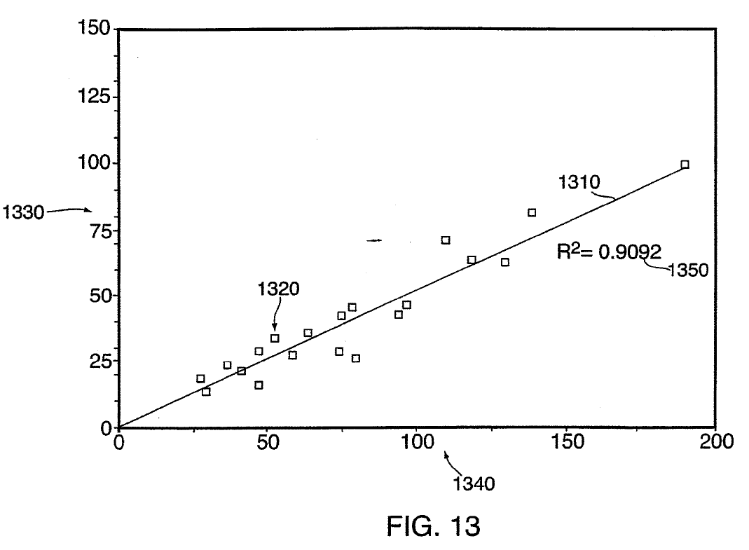

FIG. 13 shows an example regression plot of IC price versus IC cost.

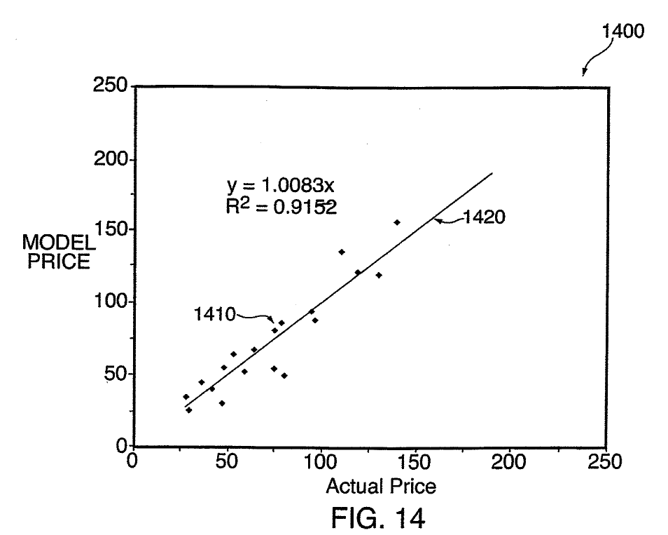

FIG. 14 shows an example regression plot of model price versus actual price.

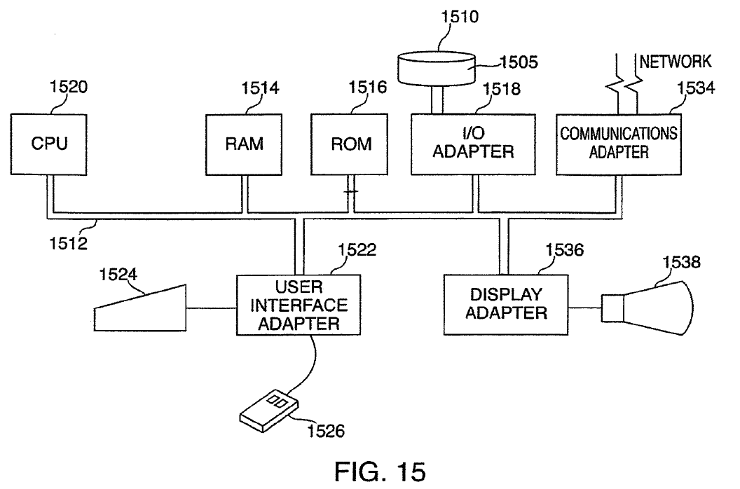

FIG. 15 shows an exemplary computing environment.

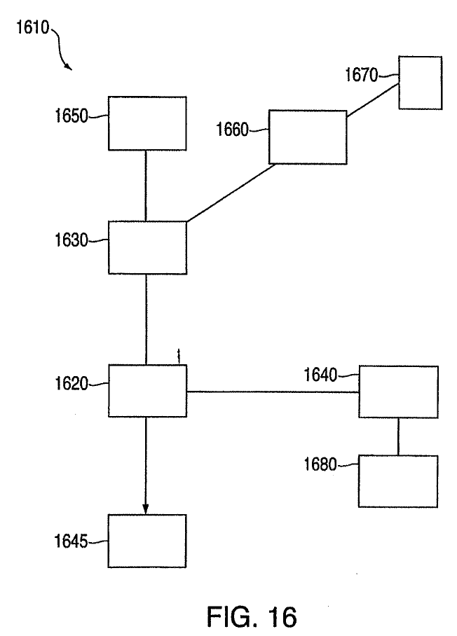

FIG. 16 shows a simplified schematic of a system according to the present invention.

### DETAILED DESCRIPTION OF THE INVENTION

The present disclosure provides a model for determining a competitive base wafer cost, a competitive packaged IC cost, a competitive IC gross margin, and a IC price for a given technology using readily available information. The specifications of an IC include, but are not limited to, the technology of the base wafer, such as the feature size and metal levels; the packaging substrate type, size, layer count, and IO count. The most significant portion of a packaged IC cost is often the cost of the processed wafer, for example a processed silicon wafer. Using a top-down approach, not used in previous models, a competitive base wafer cost can be calculated that represents a competitive cost for a given technology at a particular point in the lifecycle of that technology.

In one embodiment, the present invention provides a method of calculating a competitive base processed wafer cost for use in a model for calculating a packaged integrated circuit (IC) cost for a first integrated circuit of a first IC technology. Referring to FIG. 1, the method includes in step 110 determining a base wafer price for a first wafer technology at a desired time of analysis. As the present invention is directed to a method of determining processed wafer cost, in the interest of brevity reference will often be made to just “wafer cost” without the qualifier “processed.” As those skilled in the art will appreciate, and except where the context clearly indicates that raw, i.e., unprocessed wafer cost is being referenced, the term “wafer cost,” as used herein, is intended to mean “processed wafer cost.” In step 120 a competitive wafer gross margin for the desired time of analysis is applied to the base wafer price to determine the competitive base wafer cost in step 130. Using this top-down approach of determining a competitive base wafer cost from a base wafer price, eliminates the need for specific wafer fabrication information required in previous models. In one example, a model for calculating a packaged IC cost is provided and the competitive wafer gross margin is applied within the model.

A particular wafer technology generally has a lifespan starting with a date of initial production and ending at a date of final production. The length of a lifespan may vary, but typically is consistent, from one wafer technology to another. Processed wafer price decreases over the lifespan of the wafer technology. In the interest of brevity reference will often be made to just “wafer price” without the qualifier “processed.” As those skilled in the art will appreciate, and except where the context clearly indicates that raw, i.e., unprocessed wafer price is being referenced, the term “wafer price,” as used herein, is intended to mean “processed wafer price.” Industry wafer prices for various wafer technologies at particular points or intervals along a lifespan are readily available to those of ordinary skill. However, they are typically not available for future points or intervals along the lifespan. One example of a source of industry wafer prices includes one or more published industry reports, such as those available from Dataquest, from which processed wafer foundry prices and price ranges for a given time period can be ascertained. In one example, average, minimum, and maximum industry wafer prices are obtained for a given time from one or more published industry reports and used to determine average, minimum and maximum competitive base wafer prices.

If the desired date of analysis for a price/cost model is the current date or a time period for which industry reports exist, a base wafer price can be directly determined from such reports. IC professionals often require a date of analysis for which there are no published wafer prices. A base wafer price for such a desired date of analysis can be calculated from known industry wafer prices at particular points in its lifespan, for example the current year.

In another aspect, the present invention provides for a method of determining a base wafer price for a given technology. This method is one example of how to determine a base wafer price as in step 110 of FIG. 1. Referring to FIG. 2, the method includes in step 210 determining a preliminary wafer price for the given wafer technology for a first time for which wafer price information is available. One example of a source of a preliminary wafer price is industry published information known to those of ordinary skill, such as Dataquest silicon price reports and Semico silicon price reports. In step 220, a takedown factor corresponding to a time period between the time of the preliminary price and the desired date of analysis is determined. A takedown factor for a desired date of analysis takes into account price takedown rates based on anticipated cost improvements that impact a wafer price over the lifespan of a wafer technology from the date of the preliminary wafer price to the desired date of analysis. A takedown factor takes into account price adjustments that are applicable industry wide and, thus, a takedown rate factor is wafer technology independent. Those of ordinary skill will recognize several sources for determining a takedown factor including, but not limited to, manufacturing efficiencies, improved production yields, and any combination thereof. In step 230, the takedown factor is applied to the preliminary wafer price to determine the base wafer price in step 240. A takedown factor is expressed as a fraction of 1, ie. 1 indicates no takedown at all. For example, a takedown factor expressed as a percentage of the previous price, such as 0.96 or 96%, would be multiplied by the preliminary wafer price.

Takedown rate factors, competitive gross margins, wafer cost, and wafer price should be consistent over the lifespan of a wafer technology and conform to understood behaviors. Referring now to FIG. 3, the plot 300 illustrates a relationship between the cost 310 and price 320 for an example wafer over time. Typically, a wafer price 320 is highest at its initial introduction 330 to the marketplace (first date of production) and decreases over time. This decrease is typically due to factors, such as cost improvements and increasing market competitiveness driving reduced margins. As previously discussed, wafer cost 310 also decreases over time due to factors, such as increased manufacturing efficiencies and production yields. The area between cost 310 and price 320 represents the wafer gross margin 340 for the example wafer. Wafer gross margin 340 is also typically highest at initial introduction 330 and typically decreases over time due to factors, such as increased market competitiveness and increased product availability.

In yet another aspect, a takedown factor can be based on periodic takedown rates for all intervals between the date for which a price is known and a desired date of analysis. In one example, periodic takedown rates are assigned at intervals between a first date in the production of a wafer technology and a second date in the production of a wafer technology. One example of a first date is the introduction date of the wafer technology. One example of a second date is the terminal date of production of the wafer technology. In this example, the time from the first date to the second date corresponds to a lifespan of an industry representative wafer technology. The length of the time period can represent all, or a portion of, the length of an entire lifespan of a typical representative wafer technology such that the length will be useful in determining wafer prices for a desired range of dates of analysis. A competitive wafer gross margin and a periodic takedown rate are each associated with each interval of the time period. The competitive wafer gross margin for each interval can be determined from industry available information. The periodic takedown rate for each interval can be determined from industry available information combined with knowledge by those having an ordinary skill. In this one embodiment, two constraints apply to the association of competitive wafer gross margin and periodic takedown rate.

Referring to FIG. 4, an example of the above-described embodiment is illustrated. In step 410 a competitive wafer gross margin is determined for each interval of the time period. In step 420 a periodic takedown rate is determined for each interval of the time period from industry available periodic wafer reduction rates. In step 430 the periodic takedown rates corresponding to the time between the date of a preliminary wafer price, for example the preliminary wafer price of step 210 of FIG. 2, and a desired date of analysis are multiplied to determine a takedown factor as in step 440. The takedown factor from step 440 may be used in step 230 of FIG. 2. In determining the periodic takedown rates and competitive wafer gross margins, the following two constraints are applied.

A first constraint in this one embodiment requires that at the periodic takedown rate divided by [1 minus the corresponding competitive wafer grow margin] at each interval decrease over the time period. A second constraint in this one embodiment requires that at each interval, a value for [1 minus competitive wafer gross margin] multiplied by the product of the corresponding periodic takedown rate and those periodic takedown rates associated with intervals occurring previously in the time period, must decrease over the time period.

For example, Table 1 illustrates an example lifespan of an industry representative wafer technology ranging from initial year of production, 0, to estimated terminal year of production, 9. This example uses years as intervals. One of ordinary skill will appreciate that other intervals corresponding to any time period for which industry periodic reduction rates are available or derivable can be applied in other examples. Table 1 also shows a competitive wafer gross margin (GM) associated with each interval. For convenience in reviewing the first constraint, Table 1 also shows a value for [1 minus competitive wafer gross margin].

TABLE 1

| | | | | | | | | | | |
|---|---|---|---|---|---|---|---|---|---|---|
| Years in Production | 0 | 1 | 2 | 3 | 4 | 5 | 6 | 7 | 8 | 9 |
| Competitive Wafer | 0.6 | 0.58 | 0.55 | 0.52 | 0.48 | 0.45 | 0.41 | 0.37 | 0.33 | 0.3 |
| GM | | | | | | | | | | |
| A: [1 − Competitive | 0.4 | 0.42 | 0.45 | 0.48 | 0.52 | 0.55 | 0.59 | 0.63 | 0.67 | 0.7 |
| Wafer GM] | | | | | | | | | | |
| B: Periodic | 1 | 0.95 | 0.93 | 0.93 | 0.92 | 0.93 | 0.93 | 0.93 | 0.94 | 0.95 |
| Takedown Rate | | | | | | | | 5 | | |
| First Constraint = B/A | 2.50 | 2.26 | 2.07 | 1.94 | 1.77 | 1.69 | 1.58 | 1.48 | 1.40 | 1.36 |
| Second | | 0.39 | 0.39 | 0.39 | 0.39 | 0.38 | 0.38 | 0.38 | 0.38 | 0.38 |
| Constraint = A * product | 0.4 | 9 | 8 | 4 | 3 | 7 | 6 | 5 | 5 | 2 |
| of B's | | | | | | | | | | |

In Table 1, a competitive wafer gross margin and a periodic takedown rate are associated with each interval using industry available information and applying the two constraints discussed above. Modifications can be made to the industry available information based on the experience of the model designer and the two constraints. In Table 1, the first constraint of this one embodiment is maintained as the values of periodic takedown rate divided by [1 minus competitive wafer gross margin] decrease or remain the same over time. For example, dividing the periodic takedown rate of 0.9 corresponding to the interval for year 3 by [1 minus gross margin] corresponding to that interval, 0.48, yields a value of 1.88. The same value for the interval for year 4 is 1.79. Also in Table 1, the second constraint of this one embodiment is maintained as the values for [1 minus competitive wafer gross margin] multiplied by the product of the corresponding periodic takedown rate and those periodic takedown rates associated with intervals occurring previously in the time period decreases or remains the same over time. For example, in year 1 the value of [1−competitive wafer gross margin] multiplied by the product of periodic takedown rates up to and including year 1 is as follows:
0.42*0.95*1=0.40.

For year 2, the value is as follows:
0.45*0.9*0.95*1=0.38.

This trend repeats throughout the time period.

In yet another embodiment, a competitive wafer gross margin can be based on information obtained from industry available information relating to wafer distributions wafer technology lifecycle, maximum attainable gross margin, and minimum attainable gross margin. Wafer distributions for individual wafer foundries and foundry segments are available from industry sources. Examples of wafer distributions include, but are not limited to, wafer volume distributions and wafer revenue distributions. FIG. 5 illustrates how wafer technology fabrication of three wafer technologies 510, 520, and 530 flow through a typical wafer foundry. As would be expected, the production volume of wafer technology 510 is low starting at its initial production 540, increases to a maximum volume 550, and drops off again to low production volume near the end of production 560. The production of wafer technology 520 overlaps with that of wafer technology 510 and later in production with wafer technology 530. Extrapolating this pattern in both time directions, several wafer technologies are typically in production at any given point in time, each having differing production volumes and each commanding different gross margins based on their level of maturity. The introduction of new wafer technologies is consistent with Moore's Law.

Industry wafer technology volume distributions should assume a normal distribution. There are more than 800 wafer fabricators worldwide. Taking the Central Limit Theorem into account, the number of samplings for a given wafer technology volume distribution over time will be represented by a normal distribution. FIG. 6 illustrates an example of a wafer technology volume distribution 600 over time for a given wafer technology. Here, the gross margin of the wafer technology is represented by a normal distribution curve 610 where the distribution mean gross margin 620 is defined at maximum volume 630 and deviations 640 from the mean correspond to time intervals ranging from initial production 650 to end-of-life 660. This embodiment of the present invention takes advantage of these characteristics by translating the gross margin found in major supplier's annual reports into the gross margin of a mature technology at maximum production volumes.

In one example, a wafer technology at the statistical mode of a wafer distribution for a particular foundry is determined for a date for which industry revenue and/or volume information is available. In choosing a foundry for this example, one of ordinary skill will recognize that a properly selected single foundry can be representative of the wafer distribution for the industry. In an alternative, a plurality of foundries can be selected to approximate a representative sample of the industry wafer volume distribution. An industry available gross margin for the particular foundry for the available date is also determined from industry available information. Examples of sources for industry available gross margins include, but are not limited to, company annual reports, Provestor Investor's Guide reports, and any combination thereof. A first amount of time from the initial date of production of the wafer technology to the available date is determined. Sources of information regarding initial dates of production of various wafer technologies include, but are not limited to, the International Technology Roadmap for Semiconductors, company announcements, and any combination thereof. A function is plotted using a first point at an initial time of a gross margin versus time plot, a second point at a terminal time of the gross margin versus time plot, and a third point at the first amount of time from the initial time of the gross margin versus time plot. An example of an initial time includes an introduction date of a wafer technology and an example of a terminal time includes a terminal date of production of a wafer technology The first point corresponds to an industry maximum attainable wafer gross margin and the second point corresponds to an industry minimum attainable wafer gross margin. One of ordinary skill will recognize that industry minimum and maximum attainable wafer gross margins can be inferred from available industry publications and other sources that provide gross margin ranges for silicon foundries. Examples of sources identifying gross margin upper and lower bounds are IC Insights, Dataquest, etc. The third point corresponds to the industry available gross margin for the first foundry for the available date. One of ordinary skill will recognize that gross margins for particular foundries are available from industry publications and other sources. From the function a gross margin value is assigned at a desired point in time as a competitive wafer gross margin.

Referring to FIG. 7, one example of the above-described embodiment is illustrated. In step 710 a wafer technology at the statistical mode of a wafer volume distribution is determined. In step 720, an amount of time from the initial production of the wafer technology to the time of the wafer volume distribution is determined. In step 730 a function is plotted as described above. In step 740 a competitive wafer gross margin is determined from the function for a time in an industry representative wafer lifespan.

In another example, referring now to FIG. 8, plot 800 illustrates a wafer volume distribution 810 for an example foundry for a example year, X. The production volume for several wafer technologies, 0.13 micrometers (μm), 0.15 μm, 0.18 μm, 0.25 μm, 0.35 μm, and >0.35 μm, at the example foundry are represented in plot 800. The wafer technology at the statistical mode of this example is 0.25 μm. Referring now to Table 2, the date of initial production for various wafer technologies is provided. In this example, the date of initial production of a 0.25 μm wafer technology is in 1998. To determine the amount of time from the initial production to the date of the available foundry volume distribution would be X-1998. If X were the year 2000, then the amount of time would by 2 years.

TABLE 2

| Technology | 0.50 μm | 0.35 μm | 0.25 μm | 0.18 μm | 0.13 μm |
|---|---|---|---|---|---|
| Year of Introduction | 1995 | 1997 | 1998 | 2000 | 2002 |

Referring now to FIG. 9, a gross margin versus time plot 900 illustrates a first point 910 at an initial time of plot 900, a second point 920 at a terminal time of plot 900, and a third point 930 at the first amount of time, in this example 2 years, of plot 900. First point 910 represents an industry maximum attainable gross margin. Second point 920 represents an industry minimum attainable gross margin. Third point 930 represents an industry available gross margin for the selected foundry. A function 940 is plotted using first, second, and third points 910, 920, and 930. Plotting function 940 approximates a competitive wafer gross margin over time. Function 940 can be any form of a monotonically decreasing function. An example of a monotonically decreasing function includes, but is not limited to, a linear function that best approximates a function using first, second, and third points 910, 920, and 930. In one example, referring now to FIG. 10, a volume distribution plot 1000 similar to that of FIG. 6 is overlaid with a gross margin versus time plot 1005 similar to that of FIG. 9. Since gross margin typically decreases consistently with reduced volumes and time, plot 1000 assists in approximating a function 1040 from points 1010, 1020, and 1030. A competitive wafer gross margin can then be assigned for one or more times in the production of an industry representative wafer lifespan by using function 940.

In still yet another embodiment, a competitive packaged IC cost based on a competitive base wafer cost is used to determine an IC price for a given integrated circuit. One of ordinary skill will recognize a variety of methods for basing a packaged IC cost on a competitive base wafer cost determined according to the present invention. A competitive IC gross margin is applied to a competitive packaged IC cost to determine an IC price. The competitive IC gross margin is based on a plurality of additional IC prices of at least one additional integrated circuit.

Referring to FIG. 11, one example of the determining of an IC price is illustrated. In step 1110 a competitive IC gross margin for the sale of an integrated circuit is determined. In step 1120 the competitive IC gross margin is applied to a packaged IC cost based on a competitive base wafer cost, for example a competitive base wafer cost determined by a method as illustrated in FIG. 2. In step 1130 a packaged IC price is determined.

One example of a method for basing a packaged IC cost on a competitive base wafer cost is illustrated in FIG. 12. At step 1205 a competitive base wafer cost is adjusted to account for various cost adjustments. Examples of cost adjustments include, but are not limited to, wafer options, such as SOI, eDRAM, C4, and custom tailoring; wafer diameter adjustments, IDM adjustments; and any combinations thereof. At step 1210 the adjusted competitive base wafer cost of 1205 is further adjusted to account for dice costs in calculating a competitive cost per tested die. Examples of dice cost adjustments include, but are not limited to, adjustment for the number of die per wafer, cost of dice process, finishing cost, probe test cost, process yield adjustment, dice yield adjustment, test yield adjustment, and any combinations thereof. At step 1225 a competitive IC module cost is determined from the competitive die cost of 1210 by adjusting to account for costs associated with packaging of a die. Examples of packaging cost adjustments include, but are not limited to, substrate cost; cost of package features, such as decoupling capacitors, heat spreader, stiffener, lid, and bond & assembly cost; and any combinations thereof. At step 1230 the competitive IC module cost is further adjusted to account for additional costs associated with packaging in determining a competitive packaged IC cost. Examples of additional costs associated with packaging include, but are not limited to, module test cost, module test yield cost adjustment, reliability cost, and any combinations thereof.

In a further embodiment, a competitive IC gross margin is determined from a slope of a regression analysis of a plurality of additional IC prices versus a corresponding plurality of additional packaged IC costs. In one example, referring now to FIG. 13 and price versus cost plot 1300, a competitive IC gross margin is determined from a regression analysis 1310 of a plurality of points 1320 representing previously calculated competitive packaged IC costs 1330 versus corresponding IC prices 1340. The corresponding IC price for each competitive packaged IC cost can be determined from previous supplier price quotes, current supplier quotes, and any combination thereof. In another example, plurality of points 1320 may represent costs and prices for a plurality of wafer technologies or for a single wafer technology. Slope 1350 of regression analysis 1310 represents [1 minus the competitive IC gross margin] for application to the competitive packaged IC cost. In yet another example, the plurality of additional packaged IC costs represented by points 1320 are iteratively updated with a new competitive packaged IC cost based on each calculation of a competitive base wafer cost. This, coupled with a corresponding IC price adds a new point to plurality of points 1320 and updates the slope 1350.

FIG. 14 illustrates an example plot 1400 of IC price calculated by a method according to the present invention versus corresponding IC price provided by an industry provider. Example points 1410 are subjected to linear regression analysis 1420 which provides correlation values y=1.0083x and R²=0.9152. These correlation values show good correlation between an IC price calculated by a method according to the present invention and an actual IC price.

In yet a further embodiment, the method of the present invention can be implemented in a system including computer-executable instructions, typically included in program modules, that are executed by a conventional, general purpose computing device. Examples of conventional, general purpose computing devices include, but are not limited to, a personal computer; a handheld device, such as a personal data assistant (PDA) and a mobile telephone device; a server; and any combinations thereof. FIG. 15 illustrates an exemplary computing environment 1500. In this example, system 1505 resides in memory system 1510, such as a disk unit or tape unit. Central processing unit (CPU) 1520 is interconnected via a system bus 1512 to a random access memory (RAM) 1514, read-only memory (ROM) 1516, input/output (I/O) adapter 1518 (for bus 1512), user interface adapter 1522 (for connecting a keyboard 1524, mouse 1526, and/or other user interface device to bus 1512), communication adapter 1534 (for connection to an external network, such as a LAN, WAN, Internet, and/or WLAN), and display adapter 1536 (for connecting bus 1512 to a display device 1538).

FIG. 16 illustrates one example of a system 1610 for calculating a competitive base wafer cost for use in a model for calculating a packaged integrated circuit (IC) cost for a first integrated circuit of a first IC technology. Competitive base wafer cost determining module 1620 is in communication with base wafer price determining module 1630 and competitive wafer gross margin determining module 1640. Base wafer price determining module 1630 determines a base wafer price for a wafer technology at a desired time of analysis and provides the base wafer price to competitive base wafer cost determining module 1620. Competitive wafer gross margin determining module 1640 determines a competitive wafer gross margin for the desired time of analysis and provides the competitive wafer gross margin to competitive base wafer cost determining module 1620. Competitive base wafer cost determining module 1620 applies the competitive wafer gross margin to the base wafer price to determine a competitive base wafer cost 1645. In one example, price table 1650 is in communication with base wafer price determining module 1630 for providing a price for a specified time for a specified wafer technology to base wafer price determining module 1630. Table 3 illustrates one example of a portion of a price table. Table 3 illustrates prices for different LM values for various wafer technologies for time X.

TABLE 3

| | Time X | | | | |
|---|---|---|---|---|---|
| | 3 | 4 | 5 | 6 | 7 |
| | 3LM | 4LM | 5LM | 6LM | 7LM |
| 0.50 μm | 750 | 750 | | | |
| 0.35 μm | 1000 | 1000 | 1150 | | |
| 0.25 μm | 1100 | 1300 | 1400 | 1550 | |
| 180 nm | 1500 | 1500 | 1900 | 2000 | 2000 |
| 150 nm | | | 2600 | 2500 | 2900 |
| 130 nm | | | 3300 | 3400 | 3600 |

In another example, referring again to FIG. 16, takedown factor determining module 1660 is in communication with base wafer price determining module 1630 for providing a takedown factor to base wafer price determining module 1630. Base wafer price determining module 1630 can use a takedown factor corresponding to a time period from time X to the desired time of analysis to adjust the preliminary wafer price from price table 1650. In yet another example, periodic takedown rate table 1670 is in communication with takedown factor determining module 1660 for providing periodic takedown rates to takedown factor determining module 1660 to calculate a takedown factor. One example of a periodic takedown rate table is provide in Table 1. In still yet another example, wafer gross margin table 1680 is in communication with competitive wafer gross margin determining module 1640 for providing a competitive wafer gross margin. One example of a wafer gross margin table is provided in Table 1.

Although the invention has been described and illustrated with respect to [an] exemplary embodiment[s] thereof, it should be understood by those skilled in the art that the foregoing and various other changes, omissions and additions may be made therein and thereto, without parting from the spirit and scope of the present invention.

What is claimed is:

1. A method of calculating a competitive base wafer cost for use in a model for calculating a packaged integrated circuit (IC) cost for a first integrated circuit of a first IC technology, the method comprising:
(a) providing a model for calculating a packaged IC cost;
(b) determining a base wafer price for a first wafer technology at a desired time of analysis; and
(c) applying in the model of calculating a packaged IC cost a competitive wafer gross margin for said desired time of analysis to said base wafer price to determine the competitive base wafer cost.

2. A method according to claim 1, wherein said determining step (a) comprises:
(a) determining a preliminary wafer price for the first wafer technology at a first time;
(b) determining a takedown factor corresponding to a first time period from said first time to said desired time of analysis; and
(c) applying said takedown factor to said preliminary wafer price to determine said base wafer price.

3. A method according to claim 2, wherein said takedown factor is based on information obtained by:
(a) determining a plurality of competitive wafer gross margins, each of said plurality of competitive wafer gross margins corresponding to one of a plurality of intervals of a second time period corresponding to a lifespan of an industry representative wafer technology;
(b) determining a plurality of periodic takedown rates from industry periodic reduction rates, each of said plurality of periodic takedown rates corresponding to one of said plurality of intervals, and
(c) multiplying each said plurality of periodic takedown rates corresponding to a subset of said plurality of intervals corresponding to said first time period to determine said takedown factor,
wherein each of said plurality of periodic takedown rates divided by [1 minus a corresponding one of said plurality of competitive wafer gross margins] decreases or remains the same over said second time period, wherein the product of a first periodic takedown rate of said plurality of periodic takedown rates corresponding to a first interval of said plurality of intervals and each of said plurality of periodic takedown rates corresponding to each of said plurality of intervals occurring prior to said first interval multiplied by a corresponding one of said competitive wafer gross margin decreases or remains the same over said second time period.

4. A method according to claim 1, wherein said competitive wafer gross margin is based on information obtained by:
(a) determining a second wafer technology at the statistical mode of a wafer distribution for a first foundry for an available date;
(b) determining a first amount of time from an initial date of production of said second wafer technology to said available date;
(c) plotting a function using a first point at an initial time of a gross margin versus time plot, a second point at a terminal time of said gross margin versus time plot, and a third point at said first amount of time from said initial time of said gross margin versus time plot, said first point corresponding to an industry maximum attainable wafer gross margin, said second point corresponding to an industry minimum attainable wafer gross margin, said third point corresponding to an industry available gross margin for said first foundry for said available date; and
(d) assigning a value from said function as said competitive wafer gross margin.

5. A method according to claim 1, further comprising:
(a) assigning a first competitive IC gross margin for a sale of the first integrated circuit, the first competitive IC gross margin based on a plurality of additional IC prices of at least one additional integrated circuit; and
(b) applying said first competitive IC gross margin to a competitive packaged IC cost to determine an IC price for the first integrated circuit, said competitive packaged IC cost being based on said competitive base wafer cost.

6. A method according to claim 5, wherein said assigning step includes determining said first competitive IC gross margin from a slope of a regression analysis of said plurality of additional IC prices versus a corresponding plurality of additional packaged IC costs.

7. A method according to claim 6, wherein said assigning step involves said plurality of additional IC prices and said corresponding plurality of additional packaged IC costs being iteratively updated with a new competitive packaged IC cost based on each calculation of said competitive base wafer cost.

8. A method of calculating a competitive base wafer cost for use in a model for calculating a packaged integrated circuit (IC) cost for a first integrated circuit of a first IC technology, the method comprising:
(a) determining a base wafer price for a first wafer technology at a desired time of analysis; and
(b) applying a competitive wafer gross margin for said desired time of analysis to said base wafer price to determine the competitive base wafer cost, said competitive wafer gross margin based on information obtained by:
(i) determining a second wafer technology at the statistical mode of a wafer distribution for a first foundry for an available date;
(ii) determining a first amount of time from an initial date of production of said second wafer technology to said available date;
(iii) plotting a function using a first point at an initial time of a gross margin versus time plot, a second point at a terminal time of said gross margin versus time plot, and a third point at said first amount of time from said initial time of said gross margin versus time plot, said first point corresponding to an industry maximum attainable wafer gross margin, said second point corresponding to an industry minimum attainable wafer gross margin, said third point corresponding to an industry available gross margin for said first foundry for said available date; and
(iv) assigning a value from said function as said competitive wafer gross margin.

9. A method according to claim 8, wherein said determining step (a) comprises:
(a) determining a preliminary wafer price for the first wafer technology at a first time;
(b) determining a takedown factor corresponding to a first time period from said first time to said desired time of analysis; and
(c) applying said takedown factor to said preliminary wafer price to determine said base wafer price.

10. A method according to claim 9, wherein said takedown factor is based on information obtained by:
(a) determining a plurality of competitive wafer gross margins, each of said plurality of competitive wafer gross margins corresponding to one of a plurality of intervals of a second time period corresponding to a lifespan of an industry representative wafer technology;
(b) determining a plurality of periodic takedown rates from industry periodic reduction rates, each of said plurality of periodic takedown rates corresponding to one of said plurality of intervals; and
(c) multiplying each of said plurality of periodic takedown rates corresponding to a subset of said plurality of intervals corresponding to said first time period to determine said takedown factor,
wherein each of said plurality of periodic takedown rates divided by [1 minus a corresponding one of said plurality of competitive wafer gross margins] decreases or remains the same over said second time period, wherein the product of a first periodic takedown rate of said plurality of periodic takedown rates corresponding to a first interval of said plurality of intervals and each of said plurality of periodic takedown rates corresponding to each of said plurality of intervals occurring prior to said first interval multiplied by a corresponding one of said competitive wafer gross margin decreases or remains the same over said second time period.

11. A method according to claim 8, further comprising:
(a) assigning a first competitive IC gross margin for a sale of the first integrated circuit, the first competitive IC gross margin based on a plurality of additional IC prices of at least one additional integrated circuit; and
(b) applying said first competitive IC gross margin to a competitive packaged IC cost to determine an IC price for the first integrated circuit, said competitive packaged IC cost being based on said competitive base wafer cost.

12. A method according to claim 11, wherein said assigning step includes determining said first competitive IC gross margin from a slope of a regression analysis of said plurality of additional IC prices versus a corresponding plurality of additional packaged IC costs.

13. A method according to claim 12, wherein said assigning step involves said plurality of additional IC prices and said corresponding plurality of additional packaged IC costs being iteratively updated with a new competitive packaged IC cost based on each calculation of said competitive base wafer cost.

14. A computer readable medium containing computer executable instructions implementing a method of calculating a competitive base wafer cost for use in a model for calculating a packaged integrated circuit (IC) cost for a first integrated circuit of a first IC technology, the instructions comprising:
(a) a first set of instructions for providing a model of calculating a packaged IC cost;
(b) a second set of instructions for determining a base wafer price for a first wafer technology at a desired time of analysis;
(c) a third set of instructions for applying in the model of calculating a packaged IC cost a competitive wafer gross margin for said desired time of analysis to said base wafer price to determine the competitive base wafer cost.

15. A computer readable medium according to claim 14, wherein said first set of instructions comprises:
(a) a fourth set of instructions for determining a preliminary wafer price for the first wafer technology at a first time;
(b) a fifth set of instructions for determining a takedown factor corresponding to a first time period from said first time to said desired time of analysis; and
(c) a sixth set of instructions for applying said takedown factor to said preliminary wafer price to determine said base wafer price.

16. A computer readable medium according to claim 15, wherein said takedown factor is based on information obtained by:
(a) determining a plurality of competitive wafer gross margins, each of said plurality of competitive wafer gross margins corresponding to one of a plurality of intervals of a second time period corresponding to a lifespan of an industry representative wafer technology;
(b) determining a plurality of periodic takedown rates from industry periodic reduction rates, each of said plurality of periodic takedown rates corresponding to one of said plurality of intervals; and
(c) multiplying each of said plurality of periodic takedown rates corresponding to a subset of said plurality of intervals corresponding to said first time period to determine said takedown factor,
wherein each of said plurality of periodic takedown rates divided by [1 minus a corresponding one of said plurality of competitive wafer gross margins] decreases or remains the same over said second time period, wherein the product of a first periodic takedown rate of said plurality of periodic takedown rates corresponding to a first interval of said plurality of intervals and each of said plurality of periodic takedown rates corresponding to each of said plurality of intervals occurring prior to said first interval multiplied by a corresponding one of said competitive wafer gross margin decreases or remains the same over said second time period.

17. A computer readable medium according to claim 14, wherein said competitive wafer gross margin based on information obtained by:
(a) determining a second wafer technology at the statistical mode of a wafer distribution for a first foundry for an available date;
(b) determining a first amount of time from an initial date of production of said second wafer technology to said available date;
(c) plotting a function using a first point at an initial time of a gross margin versus time plot, a second point at a terminal time of said gross margin versus time plot, and a third point at said first amount of time from said initial time of said gross margin versus time plot, said first point corresponding to an industry maximum attainable wafer gross margin, said second point corresponding to an industry minimum attainable wafer gross margin, said third point corresponding to an industry available gross margin for said first foundry for said available date; and
(d) assigning a value from said function as said competitive wafer gross margin.

18. A computer readable medium according to claim 14, further comprising:
(a) a seventh set of instructions for assigning a first competitive IC gross margin for a sale of the first integrated circuit, the first competitive IC gross margin based on a slope of a regression analysis of plurality of additional IC prices of at least one additional integrated circuit versus a corresponding plurality of additional packaged IC costs; and
(b) a eight set of instructions for applying said first competitive IC gross margin to a competitive packaged IC cost to determine an IC price for the first integrated circuit, said competitive packaged IC cost being based on said competitive base wafer cost.

19. A computer readable medium according to claim 18, wherein said sixth set of instructions comprises an eight set of instructions for iteratively updating said plurality of earlier price quotes and said corresponding plurality of additional packaged IC costs with a new competitive packaged IC cost based on each calculation of said competitive base wafer cost.

20. A device for calculating a competitive base wafer cost, the device comprising a computer readable medium according to claim 14.
